(19) United States
(12) Patent Application Publication
(10) Pub. No.: US 2012/0144580 A1
(43) Pub. Date: Jun. 14, 2012

(54) BASIN WITH LINER

(75) Inventors: Mark Lawson, Naperville, IL (US); Walter J. Moran, Batavia, IL (US)

(73) Assignee: Elkay Manufacturing Company, Oak Brook, IL (US)

(21) Appl. No.: 13/315,444

(22) Filed: Dec. 9, 2011

Related U.S. Application Data
(60) Provisional application No. 61/421,875, filed on Dec. 10, 2010.

(51) Int. Cl. A47K 1/04; B32B 38/00; B32B 37/14

(52) U.S. Cl. 4/619; 156/221

(57) ABSTRACT

A multi-layered basin including an interior layer with at least one sidewall enclosing an area for retaining a liquid. The sidewall has an external surface for contacting the liquid and an underlying surface. A liner is attached to the underlying surface to cover at least a portion of the underlying surface. The liner is vacuum formed against the underlying surface such that the liner at least partially conforms to the shape of the underlying surface.

### CROSS-REFERENCE TO RELATED APPLICATIONS

This patent application claims the benefit of U.S. Provisional Patent Application No. 61/421,875, filed Dec. 10, 2010, the complete content of which is hereby incorporated by reference in its entirety.

### BACKGROUND

Certain basins, such as stainless steel sinks, are typically formed of a single layer of stainless steel. The steel must have a thickness sufficient to avoid deformation and survive the wear and tear experienced in an environment such as a kitchen, and the thickness of the steel can affect the cost to manufacture such basins. In addition, certain efforts have been made to attach materials to the back side surfaces of sinks to reduce noise.

### BRIEF SUMMARY

The invention provides a multi-layered basin including an interior layer with at least one sidewall enclosing an area for retaining a liquid. The sidewall has an external surface for contacting the liquid and an underlying surface. A liner is attached to the underlying surface to cover at least a portion of the underlying surface. The liner is vacuum formed against the underlying surface such that the liner at least partially conforms to the shape of the underlying surface.

The invention also provides a multi-layered basin including an interior layer having at least one sidewall enclosing an area for retaining a liquid. The sidewall has an external surface for contacting the liquid and an underlying surface. A liner is attached to the underlying surface to cover at least a portion of the underlying surface. An intermediary material is disposed between the interior layer and the liner such that the intermediary material is at least partially surrounded by the interior layer and the liner.

The invention further provides a method of forming a multi-layered basin. An interior layer is provided having at least one sidewall enclosing an area for retaining a liquid. The sidewall has an external surface for contacting the liquid and an underlying surface. A liner is disposed adjacent to the underlying surface. The liner is vacuum formed to attach the liner to the underlying surface and cover at least a portion of the underlying surface such that the liner at least partially conforms to the shape of the underlying surface.

### BRIEF DESCRIPTION OF THE DRAWINGS

FIG. 1 is a perspective view of a basin with a vacuum formed liner;

FIG. 2 is a top plan view of the basin of FIG. 1;

FIG. 3 is an enlarged fragmentary sectional view of the basin of FIG. 1;

FIG. 4 is an enlarged fragmentary sectional view showing another embodiment of the basin of FIG. 1;

FIG. 5 is an enlarged fragmentary sectional view showing another embodiment of the basin of FIG. 1;

FIG. 6 is an enlarged fragmentary sectional view showing another embodiment of the basin of FIG. 1;

FIG. 7 is a top plan view of the basin of FIG. 1 showing an untrimmed vacuum formed liner; and

FIG. 8 is a bottom view of the basin of FIG. 1 showing an untrimmed vacuum formed liner.

### DETAILED DESCRIPTION

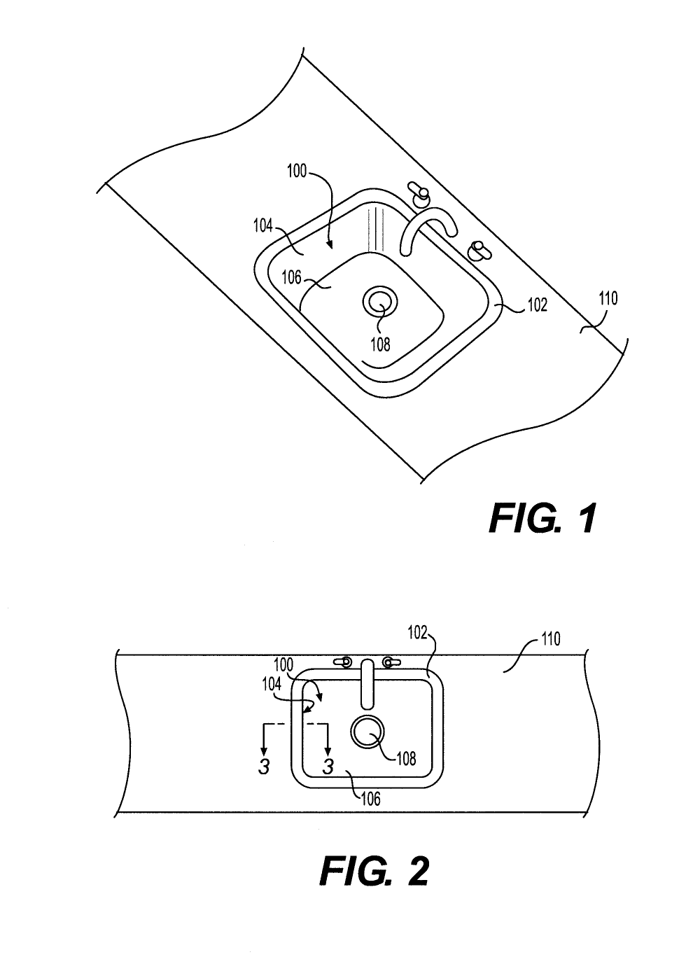

Turning to the figures, wherein like reference numerals represent like features, FIGS. 1 and 2 show a basin 100 with a vacuum formed liner. For illustration, the basin 100 is represented in the drawings as a sink. It will, however, be appreciated that the basin 100 could be any suitable structure for containing a liquid. The basin 100 can have a rim 102, one or more sidewalls 104, a base 106, and a drain 108. The one or more sidewalls 104 can extend between the base 106 and the rim 104. As shown, the basin 100 can be attached to a support structure 110 such as a counter, and the basin 100 can be mounted above or below the support structure 110. For example, an opening can be formed in the support structure 110 such that an above-mount basin can be dropped into the opening, or an under-mount basin can be attached to the underside of the support structure such that the opening in the support structure is disposed above the basin. In other embodiments, the basin could be formed as an integral part of the counter. It will be appreciated that the basin can be any suitable shape and size.

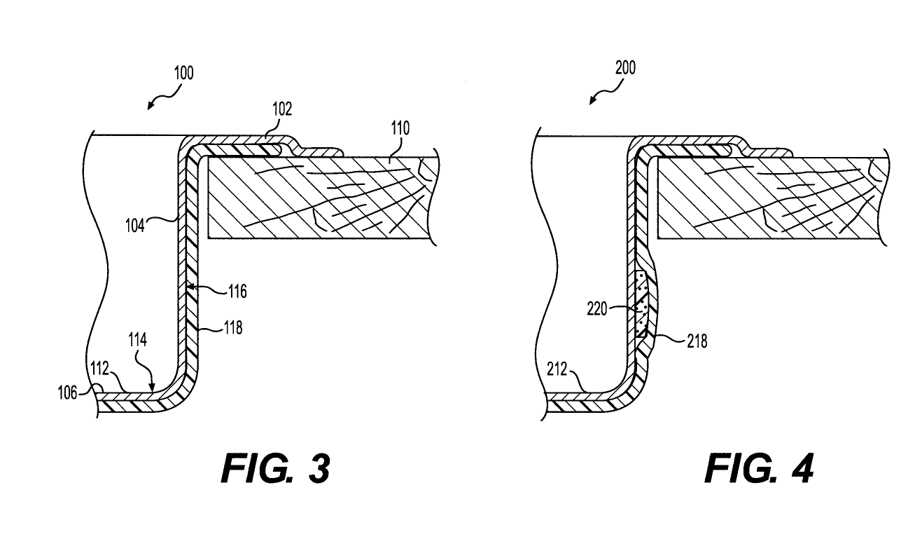

The basin 100 may have a composite structure of two or more layers. For example, as shown in FIG. 3, the basin 100 can have an interior layer 112 with a surface 114 exposed to the user and an underlying surface 116 attached to a backing layer that forms a liner 118. In the illustrated embodiment, the interior layer 112 forms the rim 102, the one or more sidewalls 104, and the base 106. The liner 118 can fully or partially cover the underlying surface 116. As shown, the basin 100 may be an above-mount basin and the liner 118 can extend over a support surface 110, such as a counter, to provide support to the rim 102. In other embodiments, the liner 118 can be trimmed or provided in a size such that it terminates before reaching the rim 102. The liner 118 can provide sufficient support and strength to the interior layer 112 such that the interior layer 112 can be manufactured with a reduced thickness than would be typically used for a single layer basin structure manufactured with the same or similar material. Accordingly, the multi-layer structure can be produced with sufficient strength but at a lower cost than a single layer basin. In addition, the combination of the liner 118 and interior layer 112 can be lighter than a single layer basin, which can make installation easier and reduce shipping costs. The liner can also provide advantages such as thermal insulation, chemical damage resistance, and/or sound deadening properties to the basin.

Referring to FIG. 4, another embodiment of a basin 200 is shown. In this embodiment, an intermediary material 220 may be disposed between the interior layer 212 and the liner 218 during the vacuum forming process to at least partially surround the intermediary material 220 with the interior layer 212 and the liner 218. The intermediary material 220 may have any suitable geometry such that it can be disposed between the interior layer 212 and the liner 218. In addition, the intermediary material 220 may be disposed in any suitable location between the interior layer 212 and the liner 218. The intermediary material 220 may be any suitable material, and may, for example, provide additional strength, thermal insulation, support, and/or sound deadening to the basin 200. Examples of some intermediary materials 220 that may be disposed between the interior layer 212 and the liner 218 include screens, fibers, cloths, re-bar, sheet metal, plates, expanded metal structures, fiber board, wood, plywood, particle board, wood composite, foam board, foam, insulation such as glass spheres, cork, mineral, mineral board, mineral wool, etc. As another example, the intermediary material 220 can include a securement mechanism (sometimes referred to as a hold-down system), such as a clip, rail, channel, or other suitable mechanism, for securing the basin 200 to a support structure. As further examples, the intermediary material 220 can be items such as wires, cables, hoses, valves, filters, gauges, optics, lights, magnets, controls, digital displays, monitors, and/or sensors that can be disposed between the interior layer 212 and the liner 218.

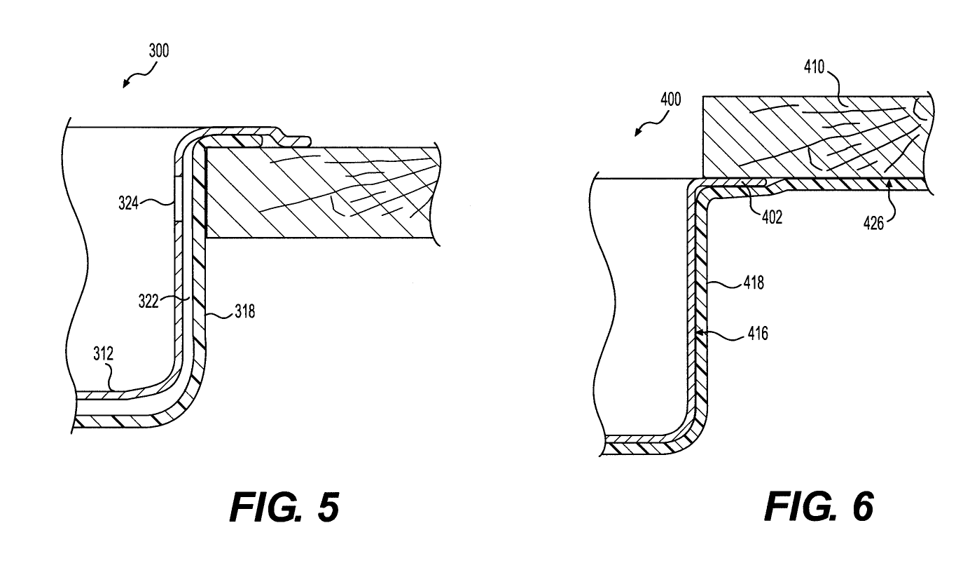

FIG. 5 shows a further embodiment of a basin 300. In this embodiment, a gap 322 may be provided between the interior layer 312 and the liner 318. The gap 322 can have any suitable shape and size and can provide a conduit for transporting liquids or gases. For example, the interior layer 312 can have an opening 324 to prevent liquid overflow within the basin 300. When a liquid reaches the level of the opening 324, the liquid will exit from the interior of the basin 300 by way of the opening 324. When the fluid enters the opening 324, it can then pass into the gap 322 which may be formed to provide a conduit for the liquid to pass to the drain. Alternately, a gap 322 may be provided that stores and/or delivers liquids or gases, such as cleaners, cleansers, disinfectants, and fragrances, to the user side of the basin 300. Furthermore, one or more gaps 322 may be formed to contain, upon assembly, some of the items mentioned above that can be disposed between the interior layer 312 and the liner 318, e.g., wires, cables, hoses, valves, filters, gauges, optics, lights, magnets, controls, digital displays, monitors, sensors, etc.

As mentioned above and shown in FIG. 6, the rim 402 of the basin 400 may be disposed below a support structure 410, such as a counter, in an under-mount arrangement. As previously discussed, the liner 418 may cover all or part of the underlying surface 416 of the interior layer 412. In addition, the liner 418 can extend beyond the periphery of the basin 400. For example, the liner 400 can be sized to extend beyond the rim 402 of the basin 400 and can attach to a bottom surface 426 of the support structure 410. In further embodiments, the liner 418 could extend beyond the rim 402 and become the support surface.

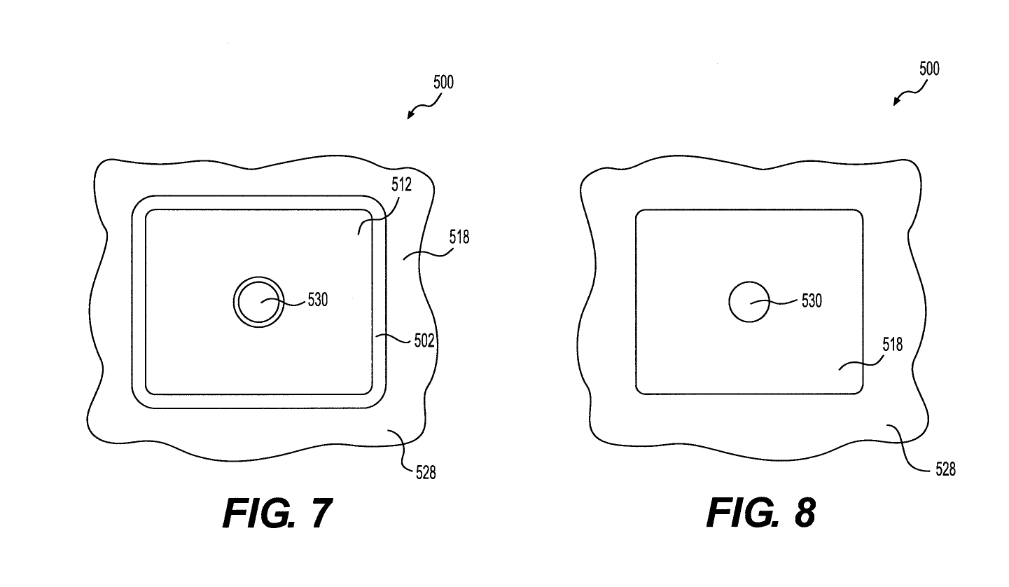

FIGS. 7 and 8 show an embodiment of the basin 500 following the vacuum forming process. The liner 518 can be vacuum formed using known vacuum forming techniques to mold the liner 518 to the interior layer 512. The interior layer 512 can be trimmed prior to or after vacuum forming the liner 518 to the interior layer 512. Likewise, holes, such as for the drain, can be cut into the interior layer 512 prior to or after vacuum forming the liner 518 to the interior layer 512. The liner 518 can be provided as a preform that fits over the interior layer 512 or as a sheet. As shown, the liner 518 can be oversized so as to conform over the entire underlying surface of the basin 500 during the vacuum forming process. The liner 518 can be preheated before vacuum forming. A frame or drop down bars may be used to secure the edges of the sheet during preheating and forming in order to minimize the sheet size and the amount of excess liner. Once the vacuum forming process is completed, the liner 500 can be trimmed to remove any excess liner 528 extending from the rim 502 or any other undesired portions of the liner 518. In addition, the portion of the liner 518 covering the drain opening at 530 can also be removed. The liner 518 can be secured to the interior layer 512 with an adhesive. A single or multi-component adhesive, glue or epoxy may either be applied onto the liner 518, onto the interior layer 512, or onto both the liner 518 and the interior layer 512 prior to adhesion. A heat activated adhesive may be used to control curing time and/or increase the bond strength between the liner 518 and the interior layer 512.

As mentioned above, one or more materials can be disposed between the interior layer and the liner during the vacuum molding process. Similarly, gaps between the interior layer and the liner can be formed during the vacuum molding process. The vacuum molding process provides the ability to manufacture a basin with a liner as described in the embodiments above and can be done relatively inexpensively compared to other molding processes that require the use of an expensive mold.

It will be appreciated that the interior layer and the liner may be formed with any suitable material. For example, the interior layer may be constructed of a metal (such as stainless steel, a copper alloy, or a copper-nickel alloy) or glass. In addition, the interior layer can have anti-bacterial properties.

The liner may be constructed of a plastic, fiberglass, or polymeric sheet. The material used for the liner may contain reinforcing whiskers, fibers, wires, cloth, screens, or other suitable materials. It will be appreciated that more than one liner may be provided.

The vacuum formed liner may be attached to any suitable basin such as a kitchen sink, a sink and counter combination, a lavatory sink, a scrub sink, a surgeon's sink, a laundry sink, a urinal, etc. Furthermore, the vacuum formed liner may be attached to a counter, vanity, scullery, etc.

It will be appreciated that, when suitable, more than one of the embodiments described above can be combined and used with a single multilayer basin.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventor for carrying out the invention. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A multi-layered basin comprising:
an interior layer having at least one sidewall enclosing an area for retaining a liquid, the sidewall having an external surface for contacting the liquid and an underlying surface; and
a liner attached to the underlying surface to cover at least a portion of the underlying surface, the liner being vacuum formed against the underlying surface such that the liner at least partially conforms to the shape of the underlying surface.

2. The multi-layered basin of claim 1 wherein the liner is secured to the interior layer with an adhesive.

3. The multi-layered basin of claim 1 further comprising an intermediary material disposed between the interior layer and the liner.

4. The multi-layered basin of claim 3 wherein the intermediary material enhances the strength of the basin.

5. The multi-layered basin of claim 3 wherein the intermediary material provides thermal insulation to the basin.

6. The multi-layered basin of claim 3 wherein the intermediary material improves the sound deadening properties of the basin.

7. The multi-layered basin of claim 3 wherein the intermediary material includes a securement mechanism for securing the basin to a support structure.

8. The multi-layered basin of claim 1 further comprising a gap between the interior layer and the liner.

9. The multi-layered basin of claim 8 wherein the gap provides a conduit for a fluid to pass therethrough.

10. The multi-layered basin of claim 1 further comprising a rim and wherein the liner extends beyond the rim.

11. A multi-layered basin comprising:
an interior layer having at least one sidewall enclosing an area for retaining a liquid, the sidewall having an external surface for contacting the liquid and an underlying surface;
a liner attached to the underlying surface to cover at least a portion of the underlying surface; and
an intermediary material disposed between the interior layer and the liner such that the intermediary material is at least partially surrounded by the interior layer and the liner.

12. The multi-layered basin of claim 11 wherein the liner is secured to the interior layer with an adhesive.

13. The multi-layered basin of claim 11 wherein the intermediary material enhances the strength of the basin.

14. The multi-layered basin of claim 11 wherein the intermediary material provides thermal insulation to the basin.

15. The multi-layered basin of claim 11 wherein the intermediary material improves the sound deadening properties of the basin.

16. The multi-layered basin of claim 11 wherein the intermediary material includes a securement mechanism for securing the basin to a support structure.

17. A method of forming a multi-layered basin comprising:
providing an interior layer having at least one sidewall enclosing an area for retaining a liquid, the sidewall having an external surface for contacting the liquid and an underlying surface;
disposing a liner adjacent to the underlying surface; and
vacuum forming the liner to attach the liner to the underlying surface and cover at least a portion of the underlying surface such that the liner at least partially conforms to the shape of the underlying surface.
